(19) United States
(12) Patent Application Publication
(10) Pub. No.: US 2009/0238198 A1
(43) Pub. Date: Sep. 24, 2009

(54) Packing Switching System and Method

(76) Inventors: Sheng-Chun Niu, Tainan (TW); Fang-Chen Chang, Tainan (TW); Shih-Chuan Lu, Tainan (TW); Ling-Hsiu Huang, Tainan (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/052,692

(22) Filed: Mar. 20, 2008

(51) Int. Cl. H04L 12/56

(52) U.S. Cl. 370/412; 370/389

(57) ABSTRACT

A packing switching system and method is disclosed. A pipelined processor processes image pixels to generate a number of bit streams. Subsequently, a packing unit packs the bit streams into packets in a way that the bit stream or streams with minimum pixel order number are packed before other bit stream or streams.

### BACKGROUND OF THE INVENTION

1. Field of the Invention

The present invention generally relates to packing bit streams, and more particularly to packing bit streams for a pipelined image compression/decompression.

2. Description of the Prior Art

Image coding or compression is one of different kinds of digital image processing. The object is to reduce redundancy of the image data such that they can be effectively stored or transmitted.

In a modern digital image processing system, a single central processing unit (CPU) is not enough to carry out all digital image processing tasks. Therefore, a digital signal processor is usually used in the digital image processing system to accelerate the processing tasks. Further, in a high-speed or real-time application, special-purpose architecture, such as a high-performance pipelined processor configuration is essential to effectively processing the tasks.

For the image compression/coding in the pipelined configuration, three color components, such as the YUV, are individually subjected to compression through each path of the pipeline configuration. However, the encoded bit streams out of each path of the pipelined configuration usually have different length for each pixel. Accordingly, in the conventional compression system, a header is added at each YUV code word for each pixel to specify lengths of the Y, U and V, respectively, such that the encoded YUV stored in a memory can be later correctly retrieved and decoded. Unfortunately, the added headers disadvantageously reduce the compression ratio, waste the memory space, and bring down the system performance.

For the foregoing reasons, a need has arisen to propose a scheme that facilitates storing the bit streams into the memory device in an efficient way, and accurately and fast retrieving the bit streams and recovering/decoding the image. Further, the operations accordingly may be operated in a real-time manner to meet the requirement of a complex and sophisticated image processing system.

### SUMMARY OF THE INVENTION

In view of the foregoing, it is an object of the present invention to provide packing switching that efficiently packs bit streams into packets for a pipelined image processing such that the packets can be later retrieved and processed fast and correctly.

According to the embodiment of the present invention, a pipelined processor (for example, a compressor) processes image pixels to generate a number of bit streams (for example, YUV). Subsequently, a packing unit packs the bit streams into packets in a way that the bit stream or streams with minimum pixel order number are packed before other bit stream or streams. The packets are then forwarded to at least two layers of buffers before they are reversely processed by another processor (for example, a de-compressor).

### BRIEF DESCRIPTION OF THE DRAWINGS

FIG. 1 illustrates a packing switching system for image compression/decompression according to one embodiment of the present invention;

FIG. 2 illustrates a flow of the algorithm used in the packing unit of FIG. 1 according to one embodiment of the present invention; and

FIGS. 3A-3G show the sequence of resultant packets in the layers of buffers regarding the example of Table 1.

### DETAILED DESCRIPTION OF THE INVENTION

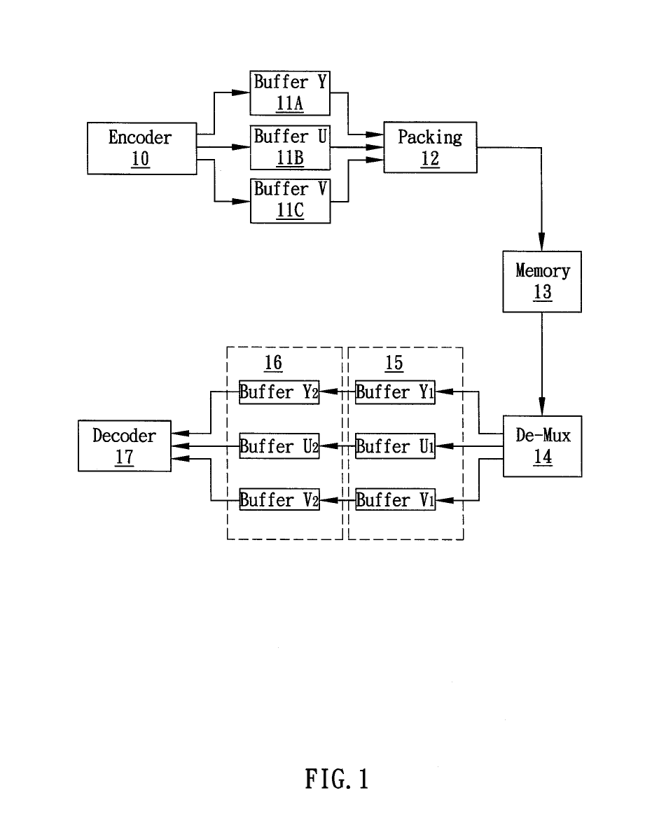

FIG. 1 illustrates a packing switching system for image compression/decompression according to one embodiment of the present invention. Although the compression/decompression is exemplified in this embodiment, the packing switching technique of the present invention may be adapted, with or without modification, to other image processing tasks.

In the embodiment, image is inputted into an encoder 10 for compression. The encoder 10 has a pipelined configuration or structure, in which a number of color components, such as YUV, are individually subjected to compression through each path of the pipelined encoder 10. The encoded bit streams out of the encoder 10 are respectively forwarded to corresponding buffers 11A-11C. In the embodiment, the buffers 11A-11C are first-in-first-out (FIFO) buffers for temporarily storing the encoded bit streams. In general, the order number of the encoded pixel out of the encoder 10 is different among the paths of the pipelined encoder 10. For example, it may be at a time that the Y component of the 19th pixel (i.e., Y(19)) has completed the compression, the U component of the 37th pixel (i.e., U(37)) has completed the compression, and the V component of the 53rd pixel (i.e., V(53)) has completed the compression.

Before the bit streams in the buffers 11A-11C are to be stored in a memory device 13, they are packed into sequence of packets by a packing unit 12, resulting in a single bit stream suitable for being stored into the memory device 13 without any header or the like. In this specification, the term unit is configured to denote a circuit, a piece of program, or their combination. The packing unit 12 determines to receive one or more of the Y component, the U component and the V component, and then packs the received components into packets in a specific manner such that a decoder 17 can accurately and fast retrieve and decode the packets from the memory device 13 without any header or the like.

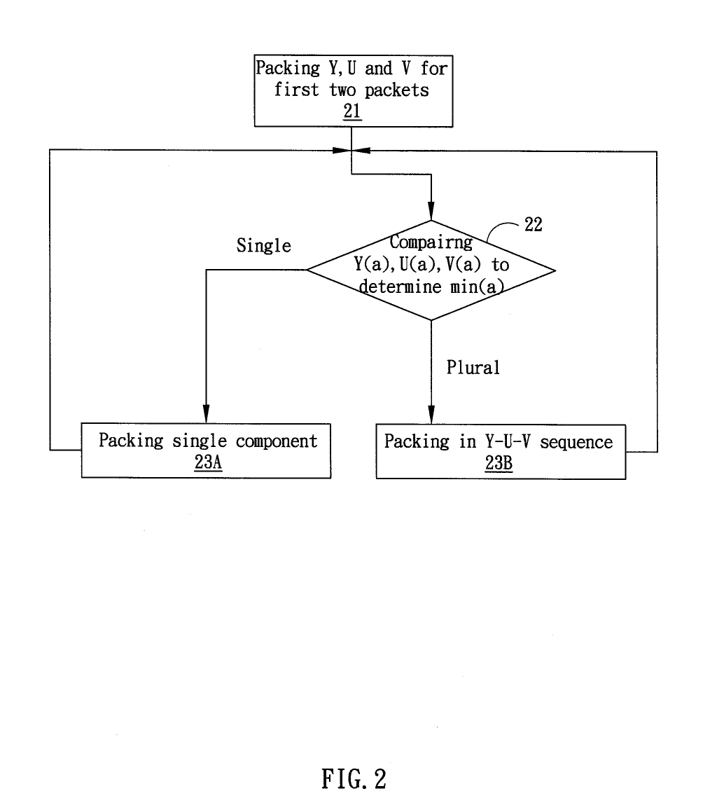

FIG. 2 illustrates a flow of the algorithm used in the packing unit 12 according to one embodiment of the present invention. For better understanding this algorithm, a simplified numerical example shown in Table 1 is illustrated, where each column represents the pixel order number of the encoded Y/U/V pixel out of the encoder 10 at the end of each coding interval or packet. For example, at the end of the third coding interval or packet, the Y component of the 13th pixel (i.e., Y(13)) has completed the compression, the U component of the 28th pixel (i.e., U(28)) has completed the compression, and the V component of the 42nd pixel (i.e., V(42)) has completed the compression.

TABLE 1

| packet | 1 | 2 | 3 | 4 | 5 | 6 |
|---|---|---|---|---|---|---|
| Y | Y(4) | Y(8) | Y(13) | Y(19) | Y(24) | Y(29) |
| U | U(10) | U(19) | U(28) | U(37) | U(53) | U(58) |
| V | V(16) | V(31) | V(42) | V(53) | V(62) | V(81) |

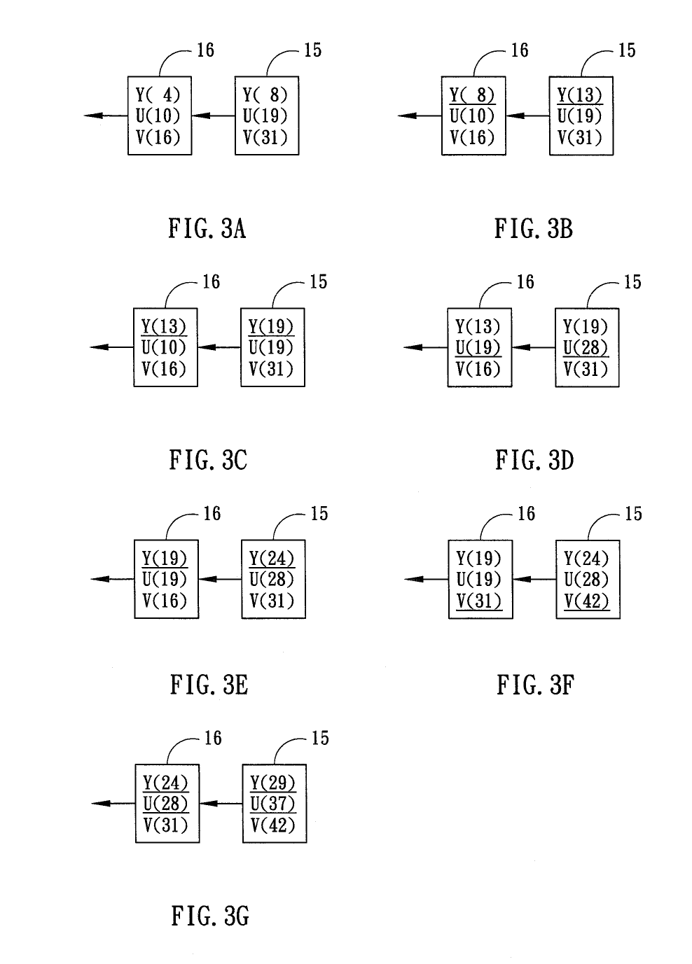

In the flow diagram shown in FIG. 2, in step 21, the Y, U and V components (i.e., Y(4), U(10), V(16)) at the end of the first coding interval are packed and stored in the memory 13, followed by packing the Y, U and V components (i.e., Y(8), U(19), V(31)) at the end of the second coding interval and storing in the memory 13. When these two packets stored in the memory 13 are later retrieved, they are forwarded by a de-multiplexer 14 to the layer-1 buffers 15 and the layer-2 buffers 16, resulting in that shown in FIG. 3A.

In step 22, the order numbers of the Y(a), U(a) and V(a) in the layer-2 buffers 16 are compared to determine the minimum order number. For example, referring to FIG. 3A, Y(4), U(10), V(16) in the layer-2 buffers 16 are compared. It is thus determined that the order number, i.e., 4, of the Y component is the minimum one among (4, 10, 16). Subsequently, as there exists only a single minimum order number, the left branch is followed to pack and store the Y component (step 23A). When this packet stored in the memory 13 is later retrieved, it is forwarded to the layer-1 buffers 15, and the content in the layer-1 buffers 15 is forwarded to the layer-2 buffers 16, resulting in that shown in FIG. 3B. Generally speaking, the U and V components accordingly wait at this stage until the order number of the U or V component is no longer greater than that of the Y component.

Similarly, the order numbers of the Y(a), U(a) and V(a) in the layer-2 buffers 16 are again compared to determine the minimum order number. Referring to FIG. 3B, Y(8), U(10), V(16) in the layer-2 buffers 16 are now compared. It is thus determined that the order number, i.e., 8, of the Y component is the minimum one among (8, 10, 16). Subsequently, as there exists only a single minimum order number, the left branch is followed to pack and store the next Y(19) component (step 23A). When this packet stored in the memory 13 is later retrieved, it is forwarded to the layer-1 buffers 15, and the content in the layer-1 buffers 15 is forwarded to the layer-2 buffers 16, resulting in that shown in FIG. 3C. The following determinations are similarly performed, resulting in FIGS. 3D to 3F, respectively.

Subsequently, referring to FIG. 3F, Y(19), U(19), V(31) in the layer-2 buffers 16 are now compared. It is determined that both the order number, i.e., 19, of the Y and U components is the minimum one among (19, 19, 31). As there exists plural minimum order numbers, the right branch is followed to pack and store the next Y(29) component and U(37) component (step 23B). In the embodiment, the Y(29) component is packed, followed by the U(37) component in the Y-U-V sequence. However, in other embodiment, other sequence, e.g., V-U-Y, can be used instead. When these packets stored in the memory 13 are later retrieved, they are forwarded to the layer-1 buffers 15, and the content in the layer-1 buffers 15 is forwarded to the layer-2 buffers 16, resulting in that shown in FIG. 3G.

In the embodiment, the packet length should be greater than maximum code length. Two layers of buffers 15 and 16 are used in the embodiment; however, more than two layers may be used instead. The length of each component buffer 15/16 is equal to the packet length in the embodiment.

According to the illustrated embodiment, the packing switching system and method facilitate storing the bit streams into the memory device in an efficient way, and accurately and fast retrieving the bit streams and recovering/decoding the image. Further, the operations accordingly may be operated in a real-time manner to meet the requirement of a complex and sophisticated image processing system.

Although specific embodiments have been illustrated and described, it will be appreciated by those skilled in the art that various modifications may be made without departing from the scope of the present invention, which is intended to be limited solely by the appended claims.

What is claimed is:

1. A packing switching system, comprising:
a pipelined processor that processes image pixels to generate a plurality of bit streams; and
means for packing the plurality of bit streams into packets in a way that the bit stream or streams with minimum pixel order number are packed before other bit stream or streams.

2. The system of claim 1, wherein the pipelined processor is a compressor.

3. The system of claim 1, further comprising a plurality of buffers for respectively storing the plurality of bit streams of the pipelined processor, before the plurality of bit streams are packed by the packing means.

4. The system of claim 1, further comprising a memory for storing the packets from the packing means.

5. The system of claim 4, further comprising at least two layers of buffers for storing packets retrieved from the memory, wherein each layer of the buffers includes a plurality of buffers.

6. The system of claim 5, further comprising a reverse processor that receives content of the at least two layers of buffers, and performs reverse operation of the pipelined processor.

7. The system of claim 5, further comprising a de-multiplexer for corresponding dispatching the stored packets of the memory into the buffers of the at least two layers of buffers.

8. The system of claim 1, wherein the packing means performs the steps of:
comparing to determine minimum pixel order number among the processed bit streams from the pipelined processor; and
packing the bit stream or streams with the determined minimum pixel order number.

9. A packing switching method, comprising:
processing image pixels to generate a plurality of bit streams; and
packing the plurality of bit streams into packets in a way that the bit stream or streams with minimum pixel order number are packed before other bit stream or streams.

10. The method of claim 9, wherein the image pixels are compressed.

11. The method of claim 9, further comprising a step of respectively storing the plurality of the processed bit streams, before the plurality of bit streams are packed.

12. The method of claim 9, further comprising providing a memory for storing the packets.

13. The method of claim 12, further comprising providing at least two layers of buffers for storing packets retrieved from the memory, wherein each layer of the buffers includes a plurality of buffers.

14. The method of claim 13, further comprising a step of receiving content of the at least two layers of buffers, and performing reverse operation of the processing step of the image pixels.

15. The method of claim 13, further comprising a step of corresponding dispatching the stored packets of the memory into the buffers of the at least two layers of buffers.

16. The method of claim 9, wherein the packing step comprises:
comparing to determine minimum pixel order number among the processed bit streams; and
packing the bit stream or streams with the determined minimum pixel order number.
